(19) United States
(12) Patent Application Publication
(10) Pub. No.: US 2004/0047618 A1
(43) Pub. Date: Mar. 11, 2004

(54) Expansion device of DVD player

(76) Inventor: Chi-Jung Chen, Shijr City (TW)

Correspondence Address: C. P. Chang, c/o Pacific Law Group LLP, Suite 525, 224 Airport Parkway, San Jose, CA, 95110, US

(21) Appl. No.: 10/642,011

(22) Filed: Aug. 15, 2003

(30) Foreign Application Priority Data
Sep. 10, 2002 (TW) 091214227

(51) Int. Cl. H04N 5/781

(52) U.S. Cl. 386/125; 386/126

(57) ABSTRACT

An expansion device of DVD player comprises an expansion slot coupled to a DVD player. The expansion device makes a general DVD player to have a variety of additional functions, not only as a DVD/VCD/CD displayer, but also as the input and output of exterior modules coupled to the expansion slot. An additional BIOS is provided in the expansion slot, which improves the abilities of the general DVD player's BIOS, such that the expansion device fully integrates the general DVD player and other components and cut down the a user's total entertainment cost while providing a variety of additional functions on a general DVD player.

### CROSS-REFERENCE TO RELATED APPLICATION

This application claims the benefit of the filing date of a Taiwan application, Ser. No. 091214227, filed Sep. 10, 2002.

### FIELD OF INVENTION

This Invention relates to an expansion device of a DVD player. More particularly, it relates to an expansion device embedded in the DVD player, which enables the DVD players not only to have the ordinary function of a DVD player, but also to conduct related functions provided by exterior parts integrated thereto. The innovation expands and upgrades the functions of a DVD player mainly by conducting an expansion slot and controller module technique. This device therefore is really a revolutionary product.

### BACKGROUND OF INVENTION

What the conventional DVD players might play was just DVDs, VCDs, and CDs. If users had other kinds of digital video demand, such as display of a scanned film, they needed to buy other respective machines, which would cost the users a substantial amount of additional expenditures and efforts. While a related technique might be found in Taiwan patent, 483566, which describes a build-in dual interchange device, whose main function is merely to transfer the signals between a CD-ROM drive and a card reader. Its ability to process related signals, however, is still restricted by the BIOS of DVD player.

Understanding the shortages of that kind of DVD player, the innovator of this product keeps researching and improving DVD players to develop this innovation.

### SUMMARY OF THE INVENTION

The purpose of this invention is to build up an expansion device for a DVD player that comprises three mainly points. The first part is an expansion slot, which links exterior parts to the DVD player. The second part is a controller module, which controls the BIOS to ensure the system to conduct the ordinary laying function and additional functions. The third part is a DVD-ROM drive, the basic exterior module, which makes the expansion device to be a DVD player.

More specifically, one aspect of the invention is to provide for a DVD player expansion device comprising a DVD player having a central processing system in internal circuit to provide a variety of functions including reading-direct, playing and accessing the media data; an expansion slot to allow exterior modules to be snapped in the DVD player; a first BIOS in the DVD player and a second BIOS in the expansion slot to control respective input/output functions thereto; a controller module to determine if the expansion device to be driven by the first BIOS in the DVD player or by the second BIOS in the expansion slot according to the variety of functions; and a DVD-ROM drive, coupled to the expansion slot, to make the expansion device working as a DVD player.

One more aspect of the invention is to provide for a DVD player expansion device of the present invention wherein the central processing system comprises a motion picture experts group (MPEG) processor, digital signal processor (DSP), and other processors which can access medium data from a variety of sources.

According to one further aspect of the invention, the DVD player of the DVD player expansion device further comprises a power to provide energy to a variety of modules; a erasable programmable read-only memory (EPROM) linked to the central processing system to provide the DVD player expansion device the capacity to run initial programs. In addition, the DVD player further comprises a synchronic dynamic random access memory (SDRAM) linked to the central processing system to provide the DVD player expansion device the capacity to access medium data. The central processing system is further connected to an integrated development environment (IDE) interface where the central processing system and the expansion slot exchange the signals between the central processing system and exterior modules. The DVD player also contains a digital to analog converter to transform digital signal to analog; and an audio/video output module.

In addition to the second BIOS described above, the expansion slot of the DVD player expansion device further comprises an integrated development environment (IDE) interface linked by the exterior modules and the IDE in the DVD player to send the signals between the central processing system and the exterior modules; a controller pin to control I/O; an Audio/Video output module to output the signals created by the central processing system; a digital to analog converter to convert digital signals to analog signals; and an Audio/Video input module to receive and send analog signals from the exterior modules to the Audio/Video output module in the DVD player.

By integrating the expansion slot and the ordinary DVD player, this innovation may easily get rid of the present shortage of the existing system. The new device therefore is really a revolutionary product.

### BRIEF DESCRIPTION OF THE DRAWINGS

The current invention will be better understood and the nature of the objectives set forth above will become apparent when consideration is given to the following detailed description of the preferred embodiments. For clarity of explanation, the detailed description further makes reference to the attached drawings herein. But the figures shown is just one of the better adapting kinds. This does not mean that it is all the usages of the techniques:

FIG. 1 illustrates the block diagram of circuit; and

FIG. 2 illustrates the flow chart of controlling process.

### DETAILED DESCRIPTION OF INVENTION

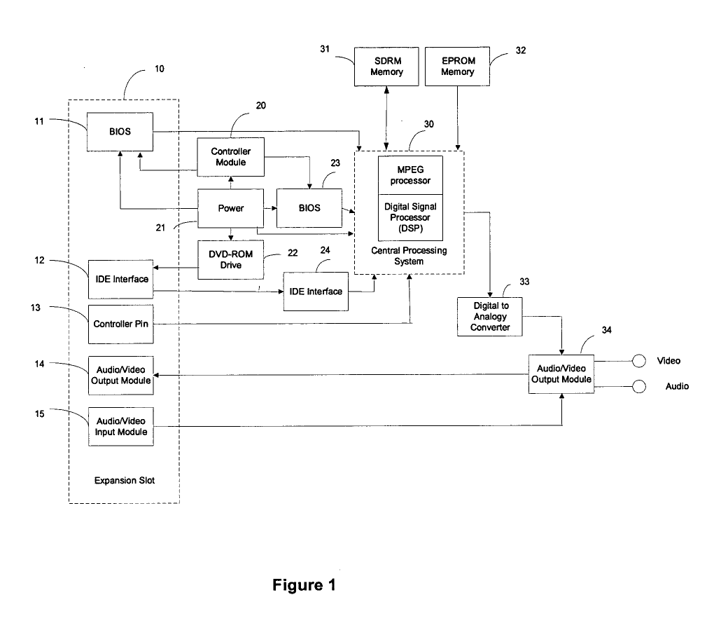

FIG. 1 illustrates the circuit block figure of the expansion device. As illustrated, a DVD player with the expansion device may enable a central processing system 30 of the DVD player to produce its best function. The reason why it works is as follows. The expansion device integrates the ordinary DVD player and the expansion slot. It thus enables the interior central processing system 30 to control both the signals of DVD-ROM drive 22 and the signals of other exterior parts, which is linked with the expansion slot 10.

Moreover, as the FIG. 1 shows, the slot part of the expansion device is linked with a power 21, with an IDE interface 24, the central processing system 30 and an Audio/Video output module 34. The expansion slot 10 of the expansion device comprises BIOS 11, an IDE interface 12, a controller pin 13, an Audio/Video output module 14 and an Audio/Video input module 15. The exterior module inputs and outputs the digital signal in the DVD player by linking with the expansion slot 10. The process is controlled by a controller module 20. The DVD player comprises the power 21, BIOS 23, the IDE interface 24, the central processing system 30 MPEG (Motion Picture Experts Group) processor and Digital Signal Processor (DSP) inside), SDRM memory (Synchronic Dynamic Random Access Memory) 31, EPROM memory (Erasable Programmable Read-Only Memory) 32, digital to analog converter 33, Audio/Video output module 34. In one embodiment, the CD-ROM is the main exterior part of this innovation. In another embodiment, If the users snap in the DVD-ROM drive 22 to the expansion slot 10, they can use the system as the normal DVD player. In addition to the CD ROM and the DVD-ROM drive, a variety of other exterior parts can be made adapted to the expansion slot 10 according to the present invention, which includes, but not limited to, CD-RW, DVD-RW, hard disk drive, floppy disk drive, scanner, MP3 player, video recorder/player, voice recorder/player, VCD-ROM, CF card, MO drive and other multimedia modules.

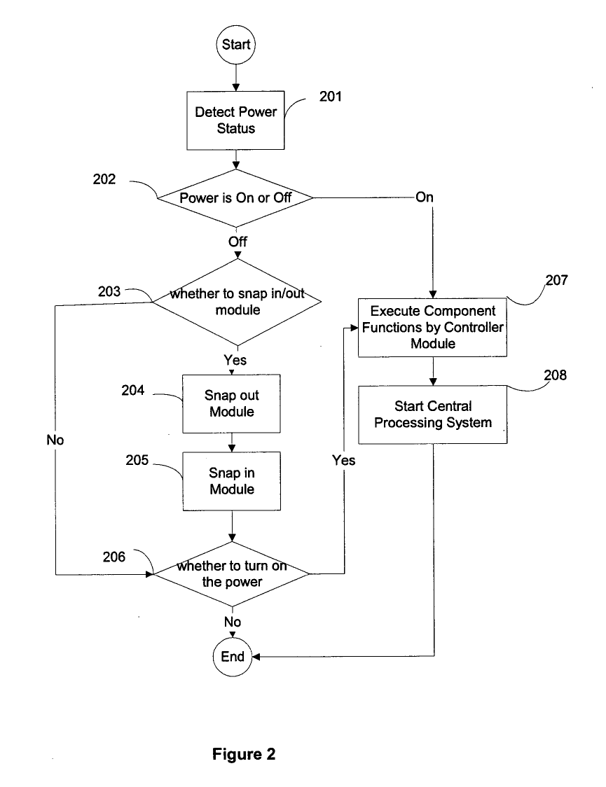

FIG. 2 illustrates the controlling process flow chart of the innovation. When the power of the system is off, the users may snap in or out the exterior module freely. When the power of the system is on, the users may run the functions of the present exterior modules.

As illustrated in FIG. 2, the stepwise controlling process according to the present invention is discussed. The system detects the power status 201 first to determine whether the power 202 is on or not. If the power is off, the user may choose whether to snap in/out module 203. If the user decides to change module, he/she must snap out module 204 and then snap in module 205. The user may decide whether to turn on the power 206 at this moment. If the power is on, the system will perform the steps of executing component functions by controller module 207, starting central processing system 208, and conducting the digital signal processing.

When the system detects the power status 201 to determine whether the power 202 is on, in the contrary the answer is yes. The system can perform the steps of executing component functions by controller module 207, starting central processing system 208, and conducting the digital signal processing.

In summary, the expansion device of DVD player according to the invention provides the following advantages and special features:

First, it adds some desirable functions to ordinary DVD players. The DVD player, therefore, may not only play DVD but also perform other related digital functions by connecting with the exterior modules, such as photograph scanner, film scanner, video recording component, and so on.

Second, it may save users the related expenditure. After buying the DVD player with this expansion device, users may flexibly purchase some other exterior modules that they need. Customers don't need to buy many machines for different functions.

The third, it may save users a lot of space. Since the expansion device according to the present invention provides a plug-and-play function, the users may easily snap in/out an exterior module when such an exterior module is desired. Its multi-functionality but less space may satisfy users a lot.

While the foregoing and the drawings are illustrative of various aspects or embodiments of the present invention, the disclosure of specific process/steps and the inclusion of specifics with regard to boarder systems and applications are not intended to limit the scope of the invention which finds itself in the various permutations of the features disclosed and described herein as conveyed to one of skill in the art.

What is claimed is:

1. A DVD player expansion device, comprising:
a DVD player having a central processing system in internal circuit to provide a variety of functions including reading-direct, playing and accessing the media data;
an expansion slot to allow exterior modules to be snapped in the DVD player;
a first BIOS in the DVD player and a second BIOS in the expansion slot to control respective input/output function thereto; a controller module to determine if the expansion device to be droved by the first BIOS in the DVD player or by the second BIOS in the expansion slot according to the variety of functions; and
a DVD-ROM drive, coupled to the expansion slot, to make the expansion device work as a DVD player.

2. The DVD player expansion device of claim 1 wherein the central processing system comprises a motion picture experts group (MPEG) processor, digital signal processor (DSP), and other processors which can access medium data.

3. The DVD player expansion device of claim 1 wherein the DVD player further comprises:
a power to provide energy to a variety of modules;
a erasable programmable read-only memory (EPROM) linked to the central processing system to provide the DVD player expansion device the capacity to run initial programs;
a synchronic dynamic random access memory (SDRAM) linked to the central processing system to provide the DVD player expansion device the capacity to access medium data;
an integrated development environment (IDE) interface linked by the central processing system and the expansion slot to exchange the signals between the central processing system and exterior modules;
a digital to analogy converter to transform digital signal to analogy one; and
an audio/video output module.

4. The DVD player expansion device of claim 1 wherein the expansion slot further comprises:
an integrated development environment (IDE) interface linked by the exterior modules and the IDE in the DVD player to send the signals between the central processing system and the exterior modules;
a controller pin to control I/O;
an Audio/Video output module to output the signals created by the central processing system and the digital to analogy converter; and
an Audio/Video input module to receive and send analog signals from the exterior modules to the Audio/Video output module in the DVD player.

5. The DVD player expansion device of claim 1 wherein the exterior modules comprising CD-ROM, CD-RW, DVD-ROM, DVD-RW, hard disk drive, floppy disk drive, scanner, MP3 player, video recorder/player, voice recorder/player, VCD-ROM, CF card, MO drive and other multimedia modules.
